(19) United States
(12) Patent Application Publication
(10) Pub. No.: US 2014/0200962 A1
(43) Pub. Date: Jul. 17, 2014

(54) DYNAMIC GEOSPATIAL RATING AND DISPLAY SYSTEM

(71) Applicant: Eddie Godshalk, San Jose, CA (US)

(72) Inventor: Eddie Godshalk, San Jose, CA (US)

(21) Appl. No.: 14/217,325

(22) Filed: Mar. 17, 2014

Related U.S. Application Data
(63) Continuation-in-part of application No. 13/554,621, filed on Jul. 20, 2012.

(51) Int. Cl. G06Q 50/16; G06Q 30/02

(52) U.S. Cl. CPC G06Q 50/16; G06Q 30/0205
USPC 705/7.34

(57) ABSTRACT

A dynamic geospatial rating and display system enables a user to select a plurality of property and/or socio-economic variables that are used to rate and/or rank geographical areas and wherein these ratings are displayed as a geospatial map wherein each of said plurality of location areas are displayed in a rating color. The dynamic geospatial rating and display system includes an algorithm that utilizes the data for computing a rating for a plurality of locations areas. A user of the system may select a geographical area for analysis as well as a resolution within the geographical area. A user may also request a rate of change display, wherein the colors relative to location areas displayed are related to the rate of change of input variables selected.

### CROSS REFERENCE TO RELATED APPLICATIONS

This application is a continuation in part of U.S. patent application Ser. No.: 13/554621, filed on Jul. 20, 2012 and entitled Method and System for Dynamic Geospatial Mapping and Visualization, which claims the benefit of U.S. Provisional patent application No.: 61/534,366, filed on Sep. 13, 2011 and entitled Methods and Systems for Dynamic Geospatial Mapping and Visualization, both of which are incorporated herein by reference in their entirety.

### BACKGROUND OF THE INVENTION

1. Field of the Invention

The present invention relates to a dynamic geospatial rating and display system that enables a user to select a plurality of property and/or socio-economic variables that are used to rate and/or rank geographical areas and wherein these ratings are displayed as a geospatial map wherein each of said plurality of location areas are displayed in a rating color. In an exemplary embodiment, a dynamic geospatial rating and display system comprises a database comprising property and/or socio-economic data and an algorithm that utilizes this data for computing a rating for a plurality of locations areas.

2. Background

Traditional geospatial mapping systems provide a real estate property listing. wherein users can define a destination search area via a user interface. The destination search area would display a geographic map. The user interface of the traditional systems would also enable the user to utilize spatial and non-spatial filters to define the geographical area as disclosed in the U.S. patent application hearing application Ser. No. 12/500,576. Additional geographic information would also be provided along with the listing. The geographic information and geographic map are also created based on data convolution and color ramp as disclosed in the Canadian patent application bearing U.S. Pat. No. 2,662,939. But neither do traditional mapping systems analyze available data to valuate real estate properties, nor do they educate users on purchasing real estate property.

In year 2010, over $1.2 trillion was transacted in the sale of existing U.S. homes using traditional valuation models that have been largely inadequate. Escalating foreclosure, mounting bank problem inventories and consumer loss of home equity have put the issue of the traditional valuation models at the forefront. Real estate investors and agents often utilize static reports based upon historical property data. The historical property data are limited to yearly, demographic and economic data. Spatial software as a service (SAAS) decision tools at the local level do not exist, and without these tools investors cannot make adequate informed decisions as to when to buy or sell the property. Hence there is a long felt unresolved need for a SAAS platform that analyzes and transforms nearest real-time data from thousands for US local and regional markets to create an effective valuation model enabling users to make adequate informed decisions.

### SUMMARY OF THE INVENTION

The invention is directed to a dynamic geospatial rating and display system that enables a user to select a plurality of property and/or socio-economic variables that are used to rate and/or rank geographical areas and wherein these ratings are displayed as a geospatial map wherein each of said plurality of location areas are displayed in a rating color. The dynamic geospatial rating and display system comprises an algorithm that utilizes the data for computing a rating for a plurality of locations areas. A display color may relate to a rating that is a relative ranking of input variables to the other location area, or may be related to an quantitative data value, such as home sales price, for example

A dynamic geospatial rating and display system, as described herein, provides a unique tool that a user can utilize to learn about different geographical locations. A dynamic geospatial rating and display system provides a user interface for selecting any number of input variables and factors that are then used to calculate a rating for a defined set of geographical areas. For example, a user may want to learn about residential property values in a city by block. The user may use an area selector to select the city of interest and then use a resolution feature to select a “block” resolution. The user may then select any number of property related variables, such as home price, size of a home, etc. The user may then direct the dynamic geospatial rating and display system to display of map of their search) criteria. A geospatial map would then be displayed with each of the blocks within the city being displayed in a color that is representative of the rating that was calculated as a function of the user's input variables. In an exemplary embodiment, a user can input property data variables and also socio-economic variables, such as crime rate, age of residents, race or residents, business density, etc, A geospatial display will be provided with any number of input variables being utilized in the algorithm to calculated a rating.

In an exemplary embodiment, a user can provided a weighted input f each of a plurality of variables. For example, a user may want to search for areas with high average household incomes, at a weighted level of 50%, high average residential home values, at a weighted level of 30% and low crime rate, with a weighted level of 20%. The algorithm would draw the relevant data from a database or databases, and utilize the weighted levels to calculate a rating for location areas within a selected area. A geospatial map would then be displayed on a display screen, wherein each of said plurality of location areas would be displayed in a rating color. For example, one block within a selected city area may be displayed in red, thereby indicating that the block had a high ratings and another block may be displayed in blue, thereby indicating that the block had a low rating. A color legend may be displayed on the map showing a ranking of the colors, with red as the highest rated areas and blue as a lower rated area, for example.

In an exemplary embodiment, a slide-bar feature is provided that enables a user to slide a weighted input for a plurality of input fields or variables. The geospatial display may dynamically change as the slide-bar(s) are manipulated by the user. This dynamic geospatial mapping enables a user to learn more about locations areas by manipulating the input variables quickly with display feedback.

In another exemplary embodiment, a rating color transparency feature is provided to change how dark a rating color is displayed on a geospatial map or over a geographical area on the geospatial map. A user may want to read see the street names or other location area details through the rating color. A user may change the darkness or transparency of a rating color over a location area or areas to enable easier identification of location area details. In addition, a zoom in/out feature may allow a user to zoom into a selected area on a geospatial map to see more detail regarding the location areas.

In still another embodiment, a resolution feature is provided to quickly change the resolution of the geospatial map, or the relative size of the locations areas that are displayed. An area selector feature may be provided for a user to select an area for analysis and geospatial mapping. For example, a person may do an initial search, use the area selector feature to select a state, and select a resolution within the state, or location areas for analysis, that are counties within a state. These are relatively large areas within the state selected area. After viewing the geospatial map with counties having different rating colors, a user may then want to look into the zip codes with one or more of the counties. The user could simply zoom into a region desired and then click on zip codes to increase the resolution of the geospatial map. A new geospatial map would be displayed with the location areas being zip code zones. A user may then zoom into a city with one of the zip code zones and select the block location area within the resolution feature to view a rating for each block within the city displayed on the screen. In this way, a user can zoom into and out of desired selected areas and change the resolution feature to provide the desired amount of detail within the display.

In still another embodiment, a user may select automatic resolution, whereby the resolution detail is automatically changed as the area of display is changed. For example, when a user is viewing a geospatial map of a state, the resolution may automatically default to counties and when the user zooms into a portion of the state, the resolution may automatically change to zip codes areas and so on. The automatic resolution feature may take into account the number of different location areas that would be displayed per location area type, state, county, zip code, tract, block, etc. Any suitable location area designation may be used in the dynamic geospatial rating and display system, as described herein, including, but not limited to, country, state, county, zip code, tract, block, etc. In an exemplary embodiment, a dynamic geospatial rating and display system is configured for a specific country, such as the United States, a specific state, such as Texas, a specific city, such as New York and the like. An area selector feature may enable a person to input an desired area by name, selecting an area displayed on a screen by clicking on that area or by zooming into or out to display a desired and selected area for analysis.

A dynamic geospatial rating and display system, as described herein may be utilized on any suitable type of user interface, such as a computer, tablet computer, lab-top computer, wireless or smart phone, and the like. Any user interface that can provide a user an input feature for selecting attributes and/or variables, provides a display and is capable of interfaces with the dynamic geospatial rating and display system software may be used.

The dynamic geospatial rating and display system is linked with a database that that includes both property data and/or socio-economic data. Property data includes, but is not limited to, information related to properties within a location area and includes, but is not limited to, property value, property size, information related to the sale of property including, days on market, date of last sale, etc., information related to the physical attributes of the property including, size, dwelling size, number of bedrooms, number of bathrooms, number of garages, etc., information related to HOA fees, taxes any outstanding leans on the property and the like. Property data may be related to residential properties or commercial properties. Socio-economic data includes, but is not limited to, information related the residents within a location area, including, population density, gender data, household income data, race data, consumer profile data and household expenditure types profile data. Profile data relates to the interest of occupations of residents with a location area. For example, how many people, or what percentage of people, within a location area own luxury vehicles. In addition, socio-economic data includes, but is not limited to, information related to commercial entities within a location area, such as business density, number or restaurants, business income data, business profile data or information related to the types of businesses, including the number of employees, employee turnover, how much they spend on various items and the like. The data within the database may include individual property and/or socio-economic data related to specific entities within the location area or it may be aggregated and median data. The database may utilize the aggregated and median data in the algorithms to compute a rating value and designate an associated rating color or shade of a color. In one embodiment, only a property data is aggregated to compute a rating and in another embodiment property and socio-economic data is aggregated to provide a rating. In addition, profile data is a specific subset of data that is related to the activities and interest of residents within an area, or to the types of businesses within a location area. Any suitable combination of input variables may be utilized in the geospatial rating and display system described herein. Any suitable type of algorithm may be used to compute a rating value for a location area, as described herein.

A user input feature may be a keyboard, point and click device such as a mouse, voice-command and/or a touch-screen. The display may provide input fields, whereby a user can click on an input field a provide input. In an exemplary embodiment, a user can click and slide bars to provide a weighted value for one or more input variables. A dynamic geospatial rating and display system, as described herein, enables a user to quickly and easily input one or more fields and obtain a geospatial map that depicts location areas with a color or color shade that is representative of the rating calculated by an algorithm for the input variables.

In an exemplary embodiment, a dynamic geospatial rating and display system, as described herein comprises a predictive algorithm, wherein the property data and/or socio-economic data comprises historical data and whereby said predictive algorithm utilizes said historical data to compute a predictive future rating. A predictive algorithm may be used to provide predictive geospatial maps, wherein a user can request a predictive map for a time period in the future, outlook time, such as six months, a year, two years and the like. A predictive algorithm may utilize the rate of change in data to predict a future rating value for a location area. A predictive algorithm may also take into account other variable that are not directly related to the data rate of change, such as national data, trends and the like. An outlook feature may be provided that enables a user to quickly change the time period for prediction and may be a slide bar that enables sliding from six months to one year to eighteen months, to two years, for example, all while the geospatial map is dynamically changing. Any suitable outlook period may be input for a predictive analysis. A predictive analysis may utilize historical data that is at least about two years prior to use, at least about four years prior to use, at least about six years prior to use, at least about eight years prior to use.

In an exemplary embodiment, a user may select a rate of change display, that shows the rate, or amount of change of a rating for a location area over a period of time. In an exemplary embodiment, a user may simply select a number of input field variables and select the rate of change display. The geospatial display provided may be the rate, a computation summation of the rate of change of the input variable(s), at the current time. In another exemplary embodiment, a user may input an outlook period and select a rate of change to determine what the rate of change may be in the future. The rate of change calculated by the algorithm may be linear over a time period or in a predictive calculation may be non-linear, whereby the rate of change further into the future may be estimated as higher than the rate of change currently. In still another embodiment, a user may input a first rate-of-change date and second rate-of-change date and an algorithm will calculate a rate of change for input variables from the first to the second rate-of-change dates. The first rate-of-change date may be limited to the historical data for a given input variable however. For example, a user may select a number of input variables and then select a first rate-of-change date that is four year prior to the time of use of the system. The user may then select a second rate-of-change date that is the present date and the algorithm will calculate a rate of change rating and/or value for location areas over the time period selected. A rate-of-change period may expand over a past period and be a historical rate-of change period, such as from eight years back to four years back, or may be historical to present or to a future date. A rate-of-change geospatial map provides insight into what areas are the hottest for a particular set of input variables.

Described are several techniques employed to transform the way people make home investment decisions. Using complex proprietary valuation models and spatial predictive models, the invention disclosed herein delivers home estimates and forecasts, enabling users to adequately assess risk and improve their profits. Embodiments of the invention are backed by a query-able system, a geospatial database of current datasets, and a geospatial database of latitude/longitude datasets (property datasets, for example that are clustered into a geospatial database), having outputs of dynamic heat maps, or maps that display location areas in colors representative of their calculated rating, and interactive reports. Embodiments of the invention also allow users to locate a desired block, track or zip code, based upon user defined tiered ranking or weighting query to, subsequently find a property.

The present invention presents a computer-implemented method for acquiring geospatial data, compiling the geospatial data and providing an interactive visual representation of the geospatial data based on user input. The computer implemented method acquires and evaluates geospatial data from one or more vendors. Each of the vendors provides historical geospatial data under multiple categories. The categories comprise national variables, metro market datasets, monthly/quarterly datasets, and all national property datasets. The computer implemented method compiles the variables from the acquired and evaluated geospatial data into individual geospatial datasets and a standard database. The geospatial datasets comprise Census Block, Census Block Group, Census Tract, Zip Codes, neighborhoods, cities, counties, metro markets and states.

The computer implemented method loads a twenty four month geospatial forecast with statistical confidence based on multiple mathematical processes performed on the individual geospatial datasets by a predictive engine. The user is provided with user-defined, ranked or tiered weighted searches comprising multiple choices for generating the dynamic geospatial maps. The dynamic geospatial maps are visually represented as heat maps. The dynamic geospatial maps are generated from the geospatial forecast. Further more, the user is allowed to slide a spatial slider. The user dynamically accesses all spatial boundary information in a report, a form, a web pages or a dynamic map

The summary of the invention is provided as a general introduction to some of the embodiments of the invention, and is not intended to be limiting. Additional example embodiments including variations and alternative configurations of the invention are provided herein.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

### DETAILED DESCRIPTION OF THE ILLUSTRATED EMBODIMENTS

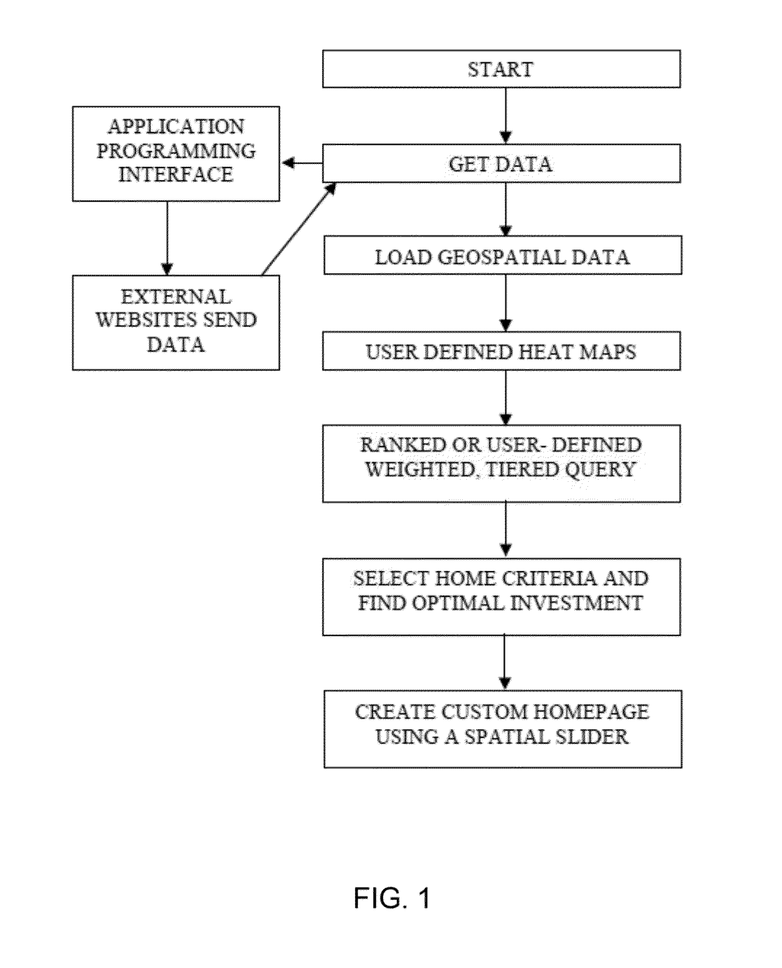

FIG. 1 shows a flowchart illustrating the sequence of steps for acquiring geospatial data, compiling the geospatial data and providing an interactive visual representation of the geospatial data based on user input

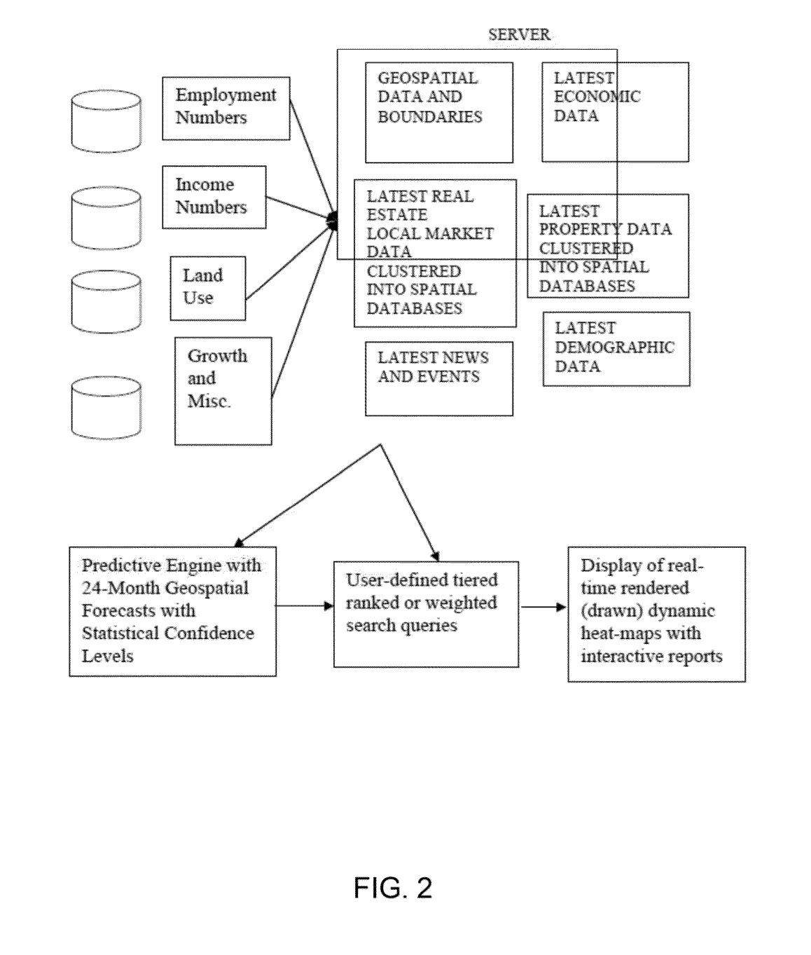

FIG. 2 illustrates a system for loading of geospatial data.

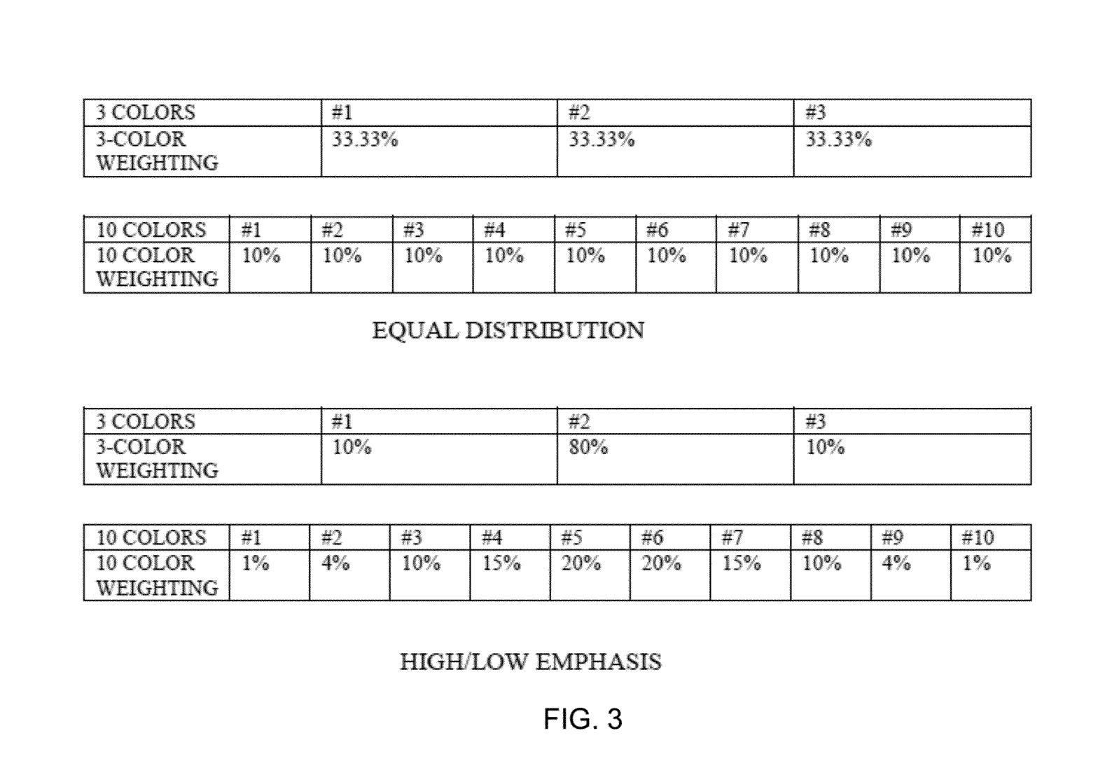

FIG. 3 illustrates color distributions within dynamic heat maps

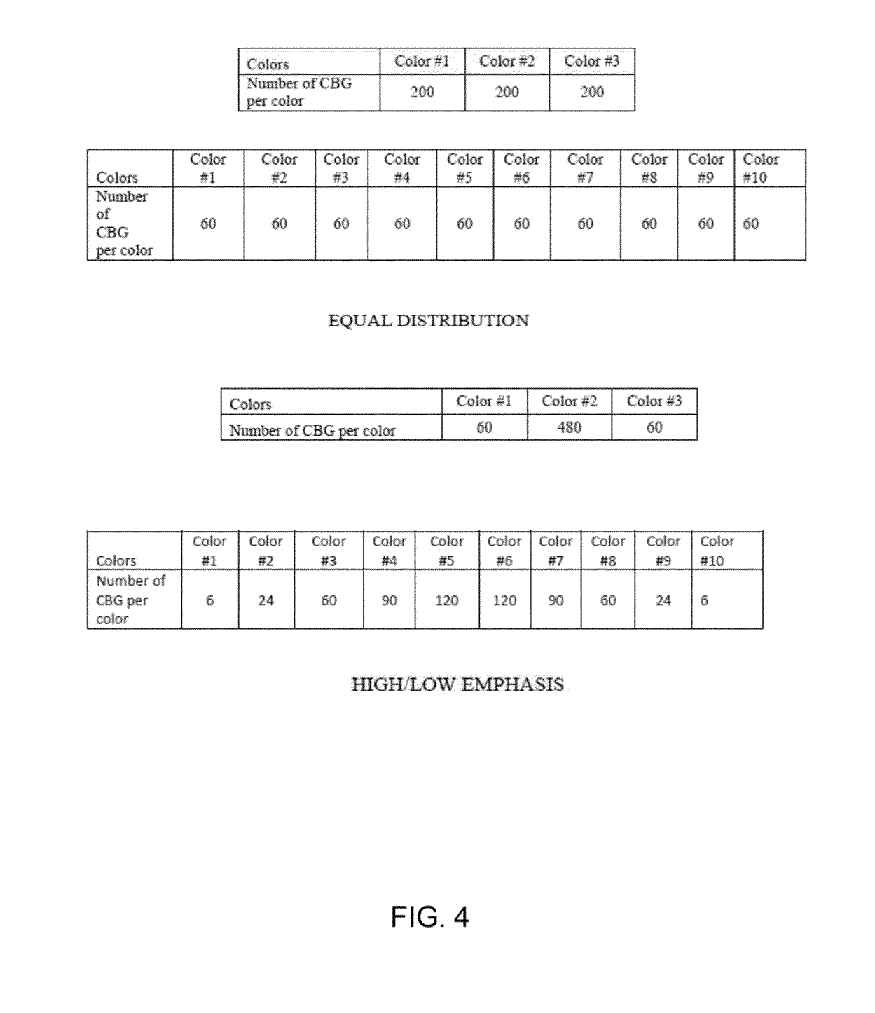

FIG. 4 illustrates color distributions with a metro market of 600 Census Block Groups within dynamic heat maps

FIG. 5 illustrates different types of geospatial sliders

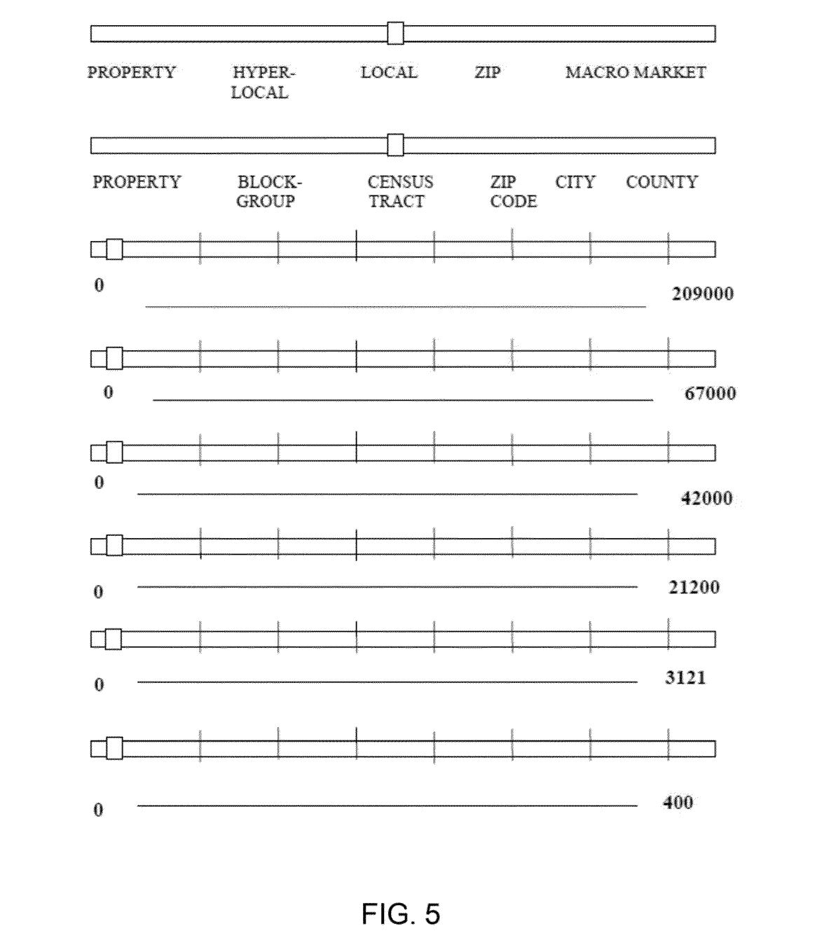

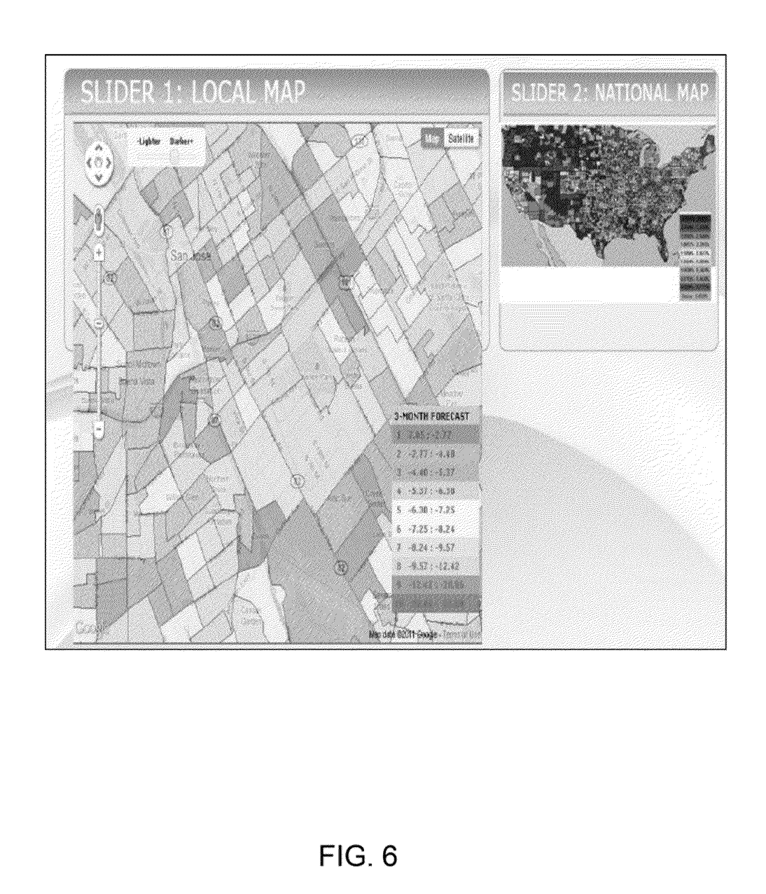

FIG. 6 depicts geospatial maps drawn in real time.

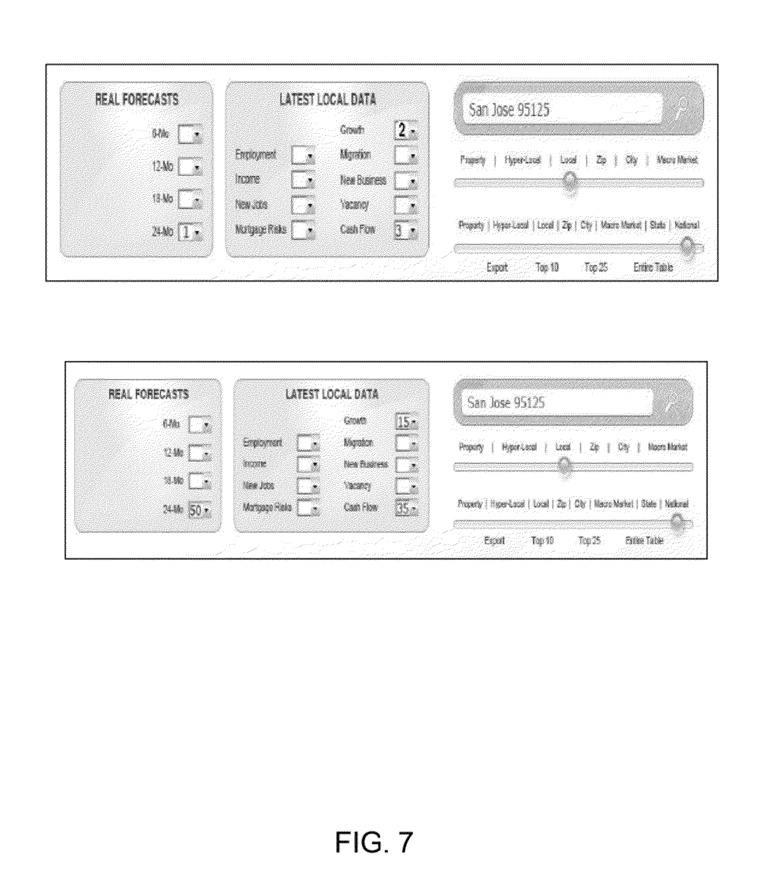

FIG. 7 depicts ranked or user-defined weighted tiered query.

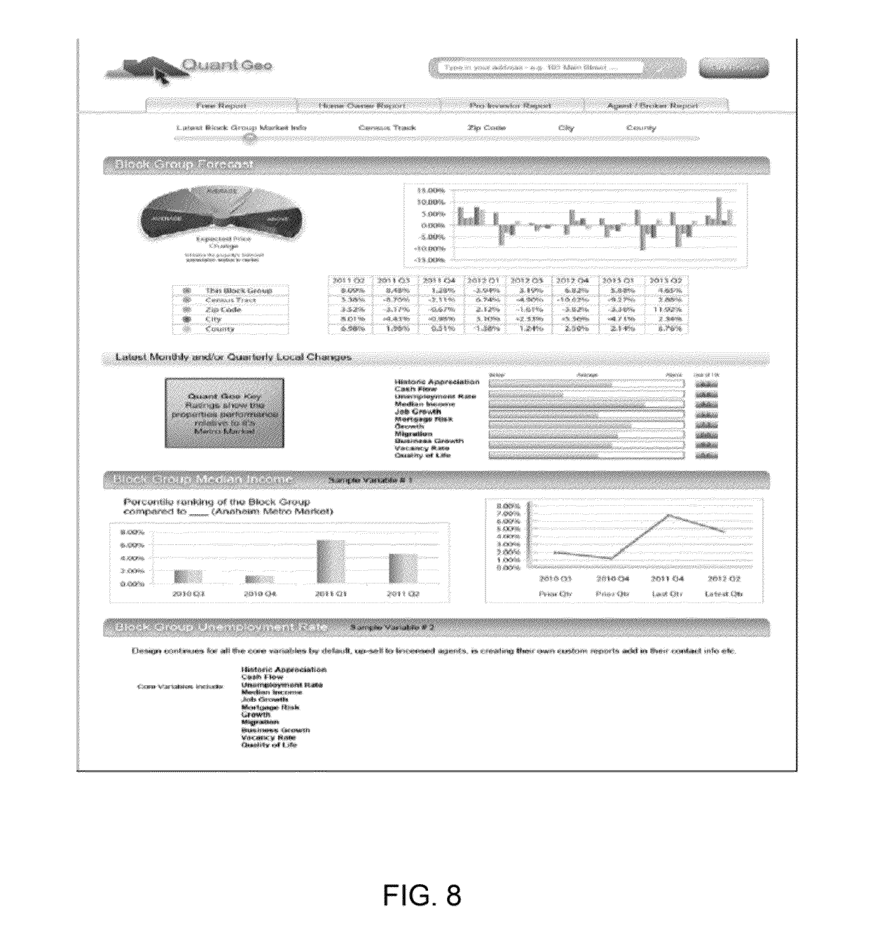

FIG. 8 depicts dynamic heat maps comprising one geospatial slider for user-defined interactive reports.

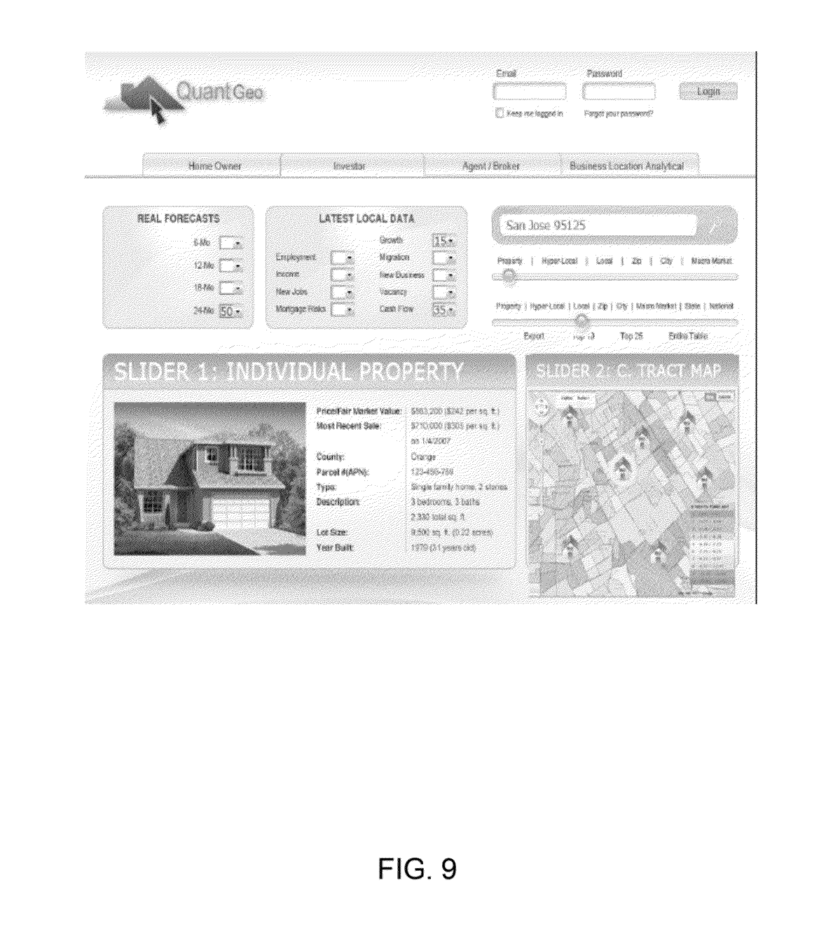

FIG. 9 depicts dynamic heat maps comprising two geospatial sliders for user-defined interactive reports.

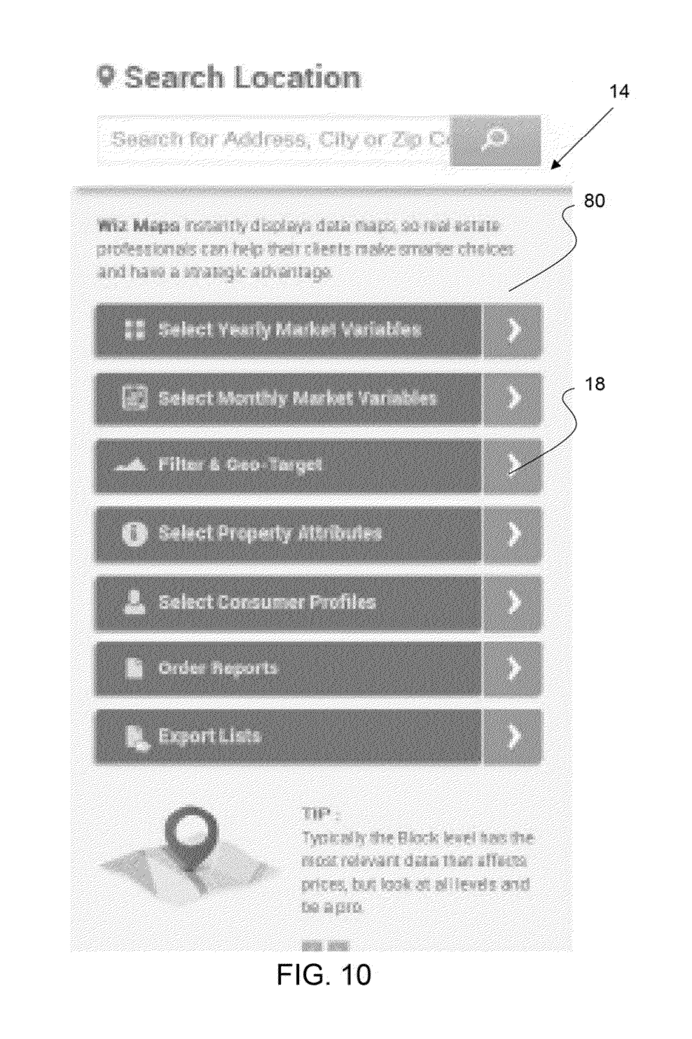

FIG. 10 shows an exemplary display of some of the exemplary user input interface options.

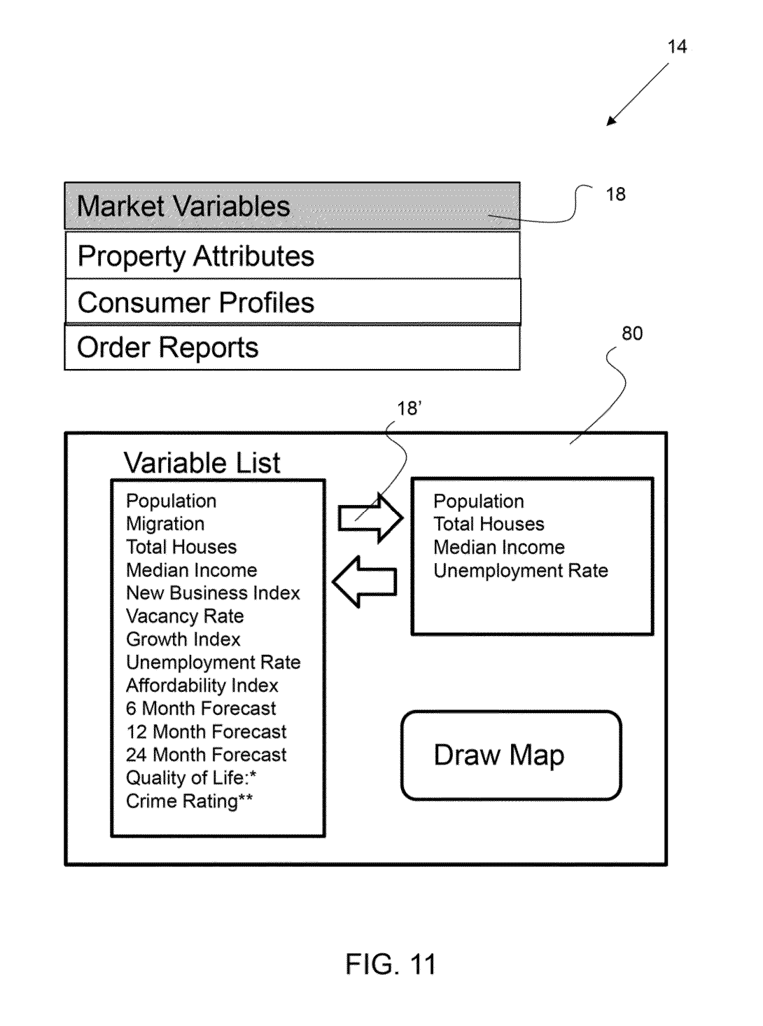

FIG. 11 shows an exemplary representation of a display of a user input interface for selecting market variable.

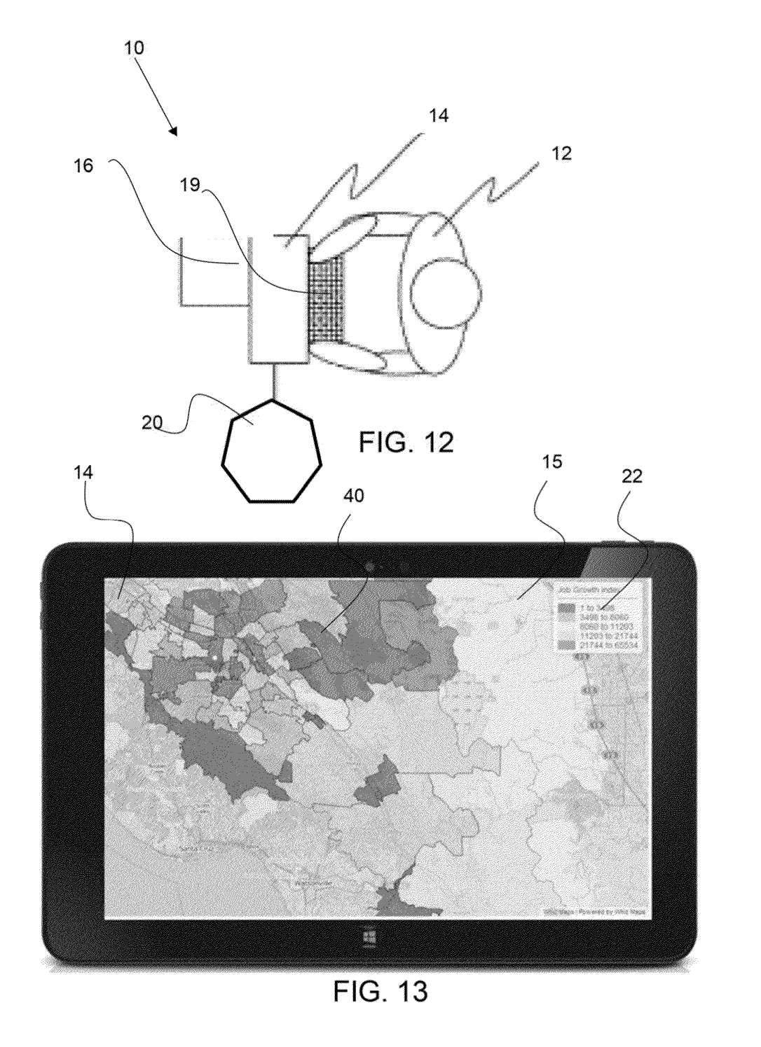

FIG. 12 shows a top-down view of an exemplary representation of a system user interfacing with a computer having a display to utilize a dynamic geospatial rating and display system as described herein.

FIG. 13 shows an exemplary display of a geospatial map on tablet computer; wherein each of said plurality of location areas are displayed in a rating color relative their computed rating.

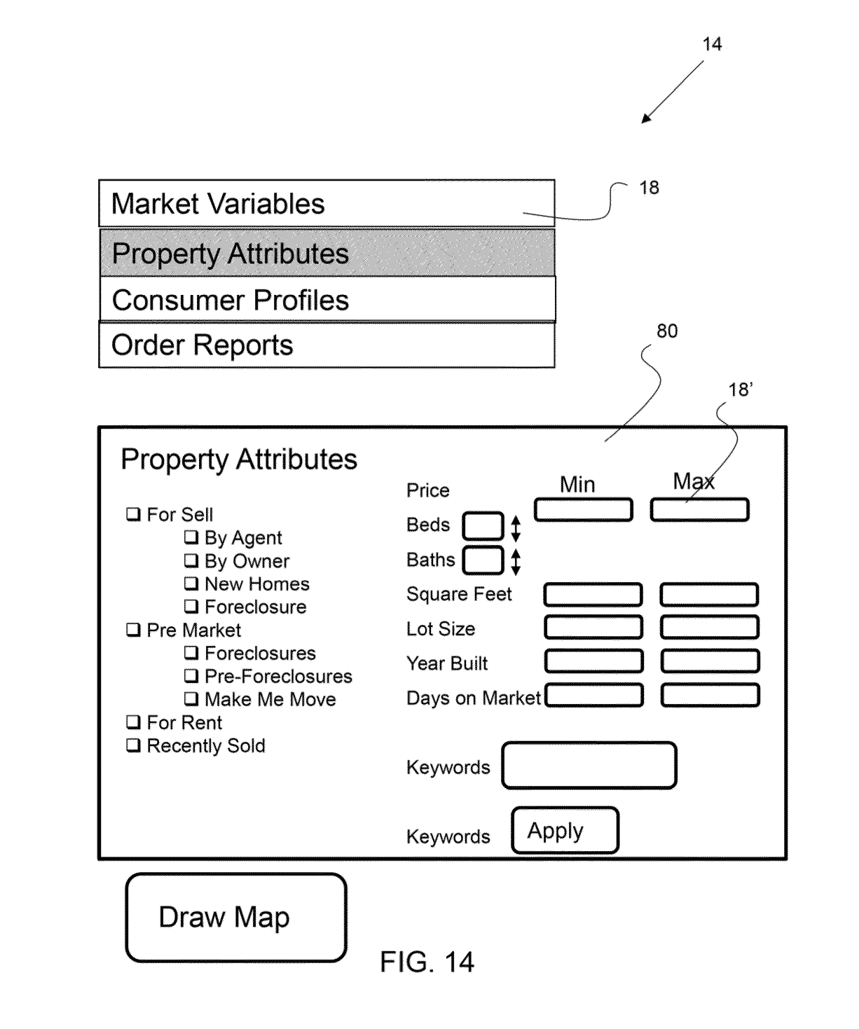

FIG. 14 shows an exemplary representation of a display of a user input interface for property attributes.

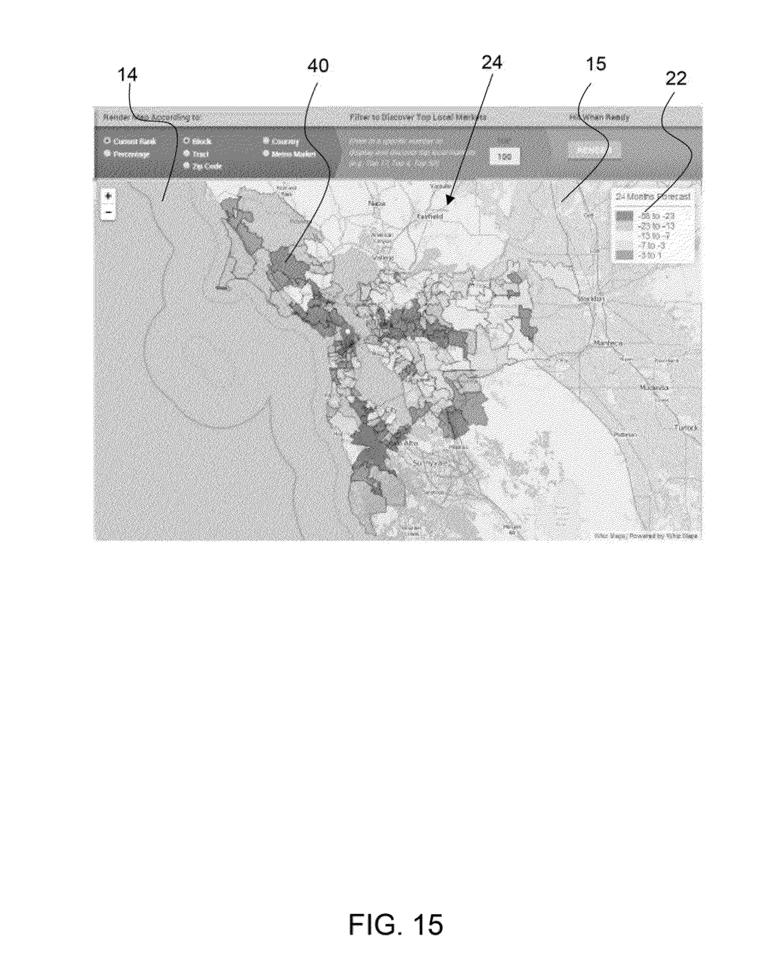

FIG. 15 shows an exemplary display of a geospatial map, wherein each of a plurality of location areas are displayed in a rating color relative their computed rating of home prices.

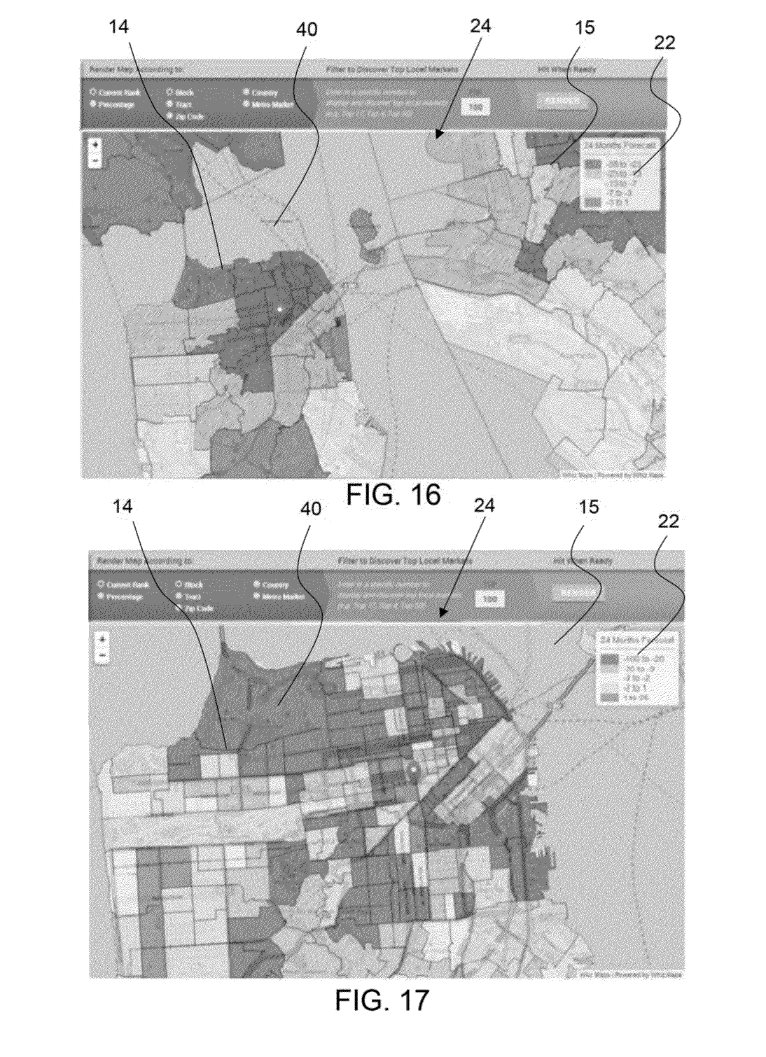

FIG. 16 shows an exemplary display of a geospatial map, wherein each of a plurality of zip code location areas are displayed in a rating color relative their computed rating.

FIG. 17 shows an exemplary display of a geospatial map, wherein each of a plurality of tract location areas are displayed in a rating color relative their computed rating.

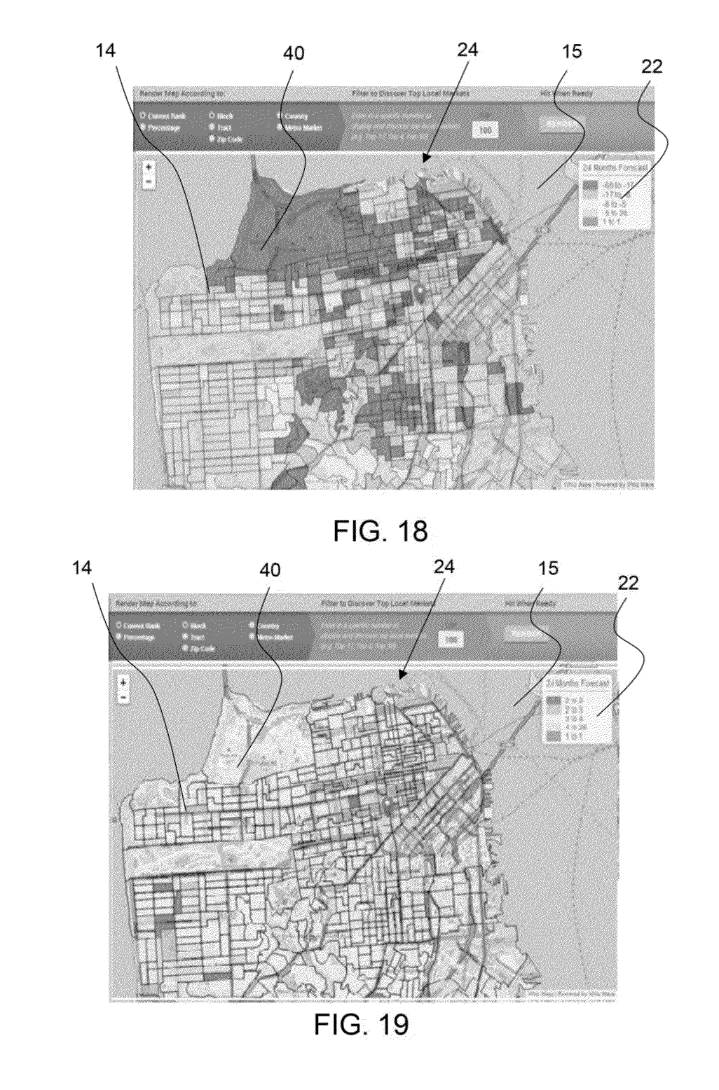

FIG. 18 shows an exemplary display of a geospatial map, wherein each of a plurality of block location areas are displayed in a rating color relative their computed rating.

FIG. 19 shows an exemplary display of a geospatial map, wherein each of a plurality of block location areas are displayed in a rating color relative their computed rating that has been filtered by a user.

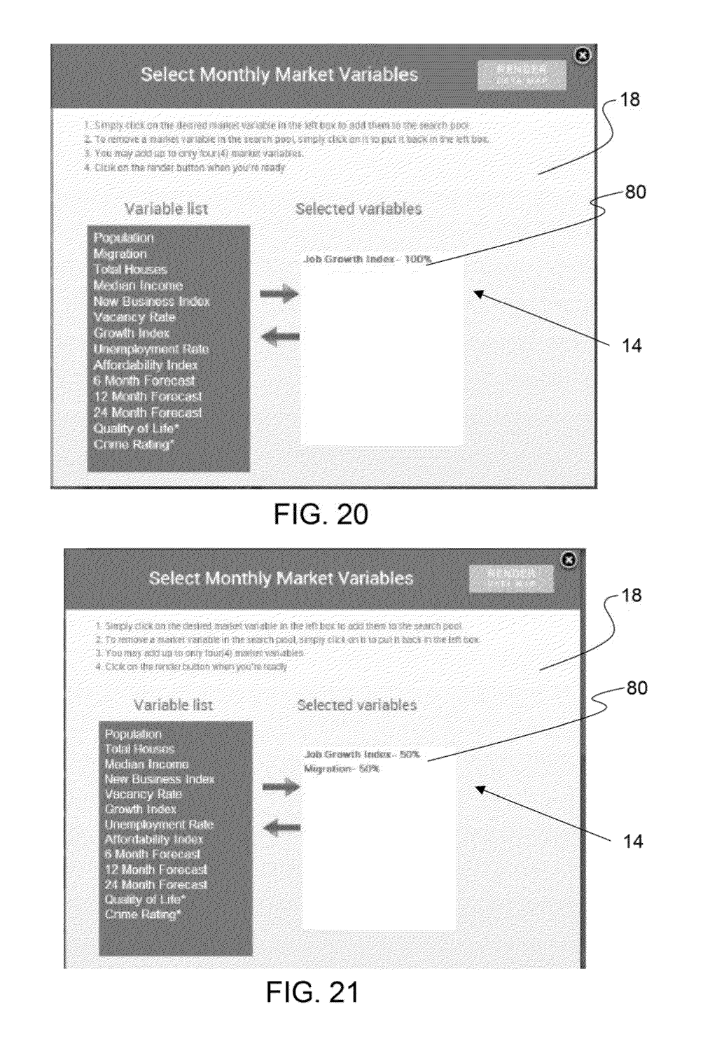

FIGS. 20 through 22 show exemplary displays of a user input interface for selection of variables with an associated weight.

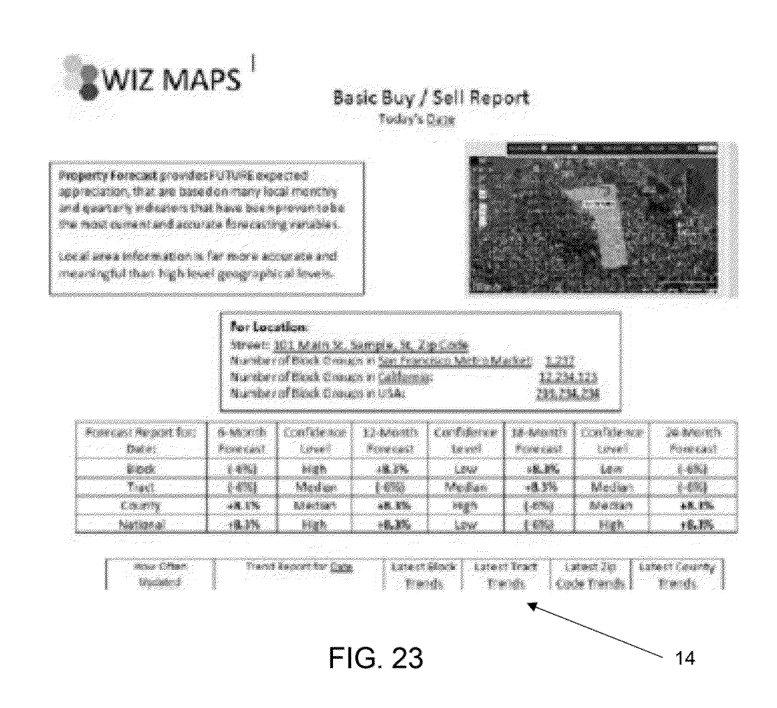

FIG. 23 shows an exemplary display of a table having computed ratings for block, track, county and national.

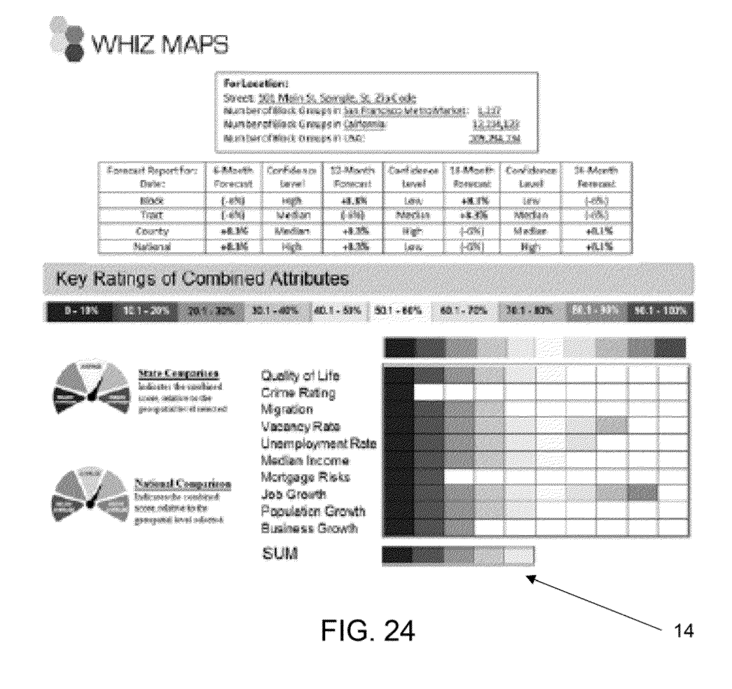

FIG. 24 shows an exemplary display of a table having computed ratings for combined attributes including property data attributes and socio-economic attributes.

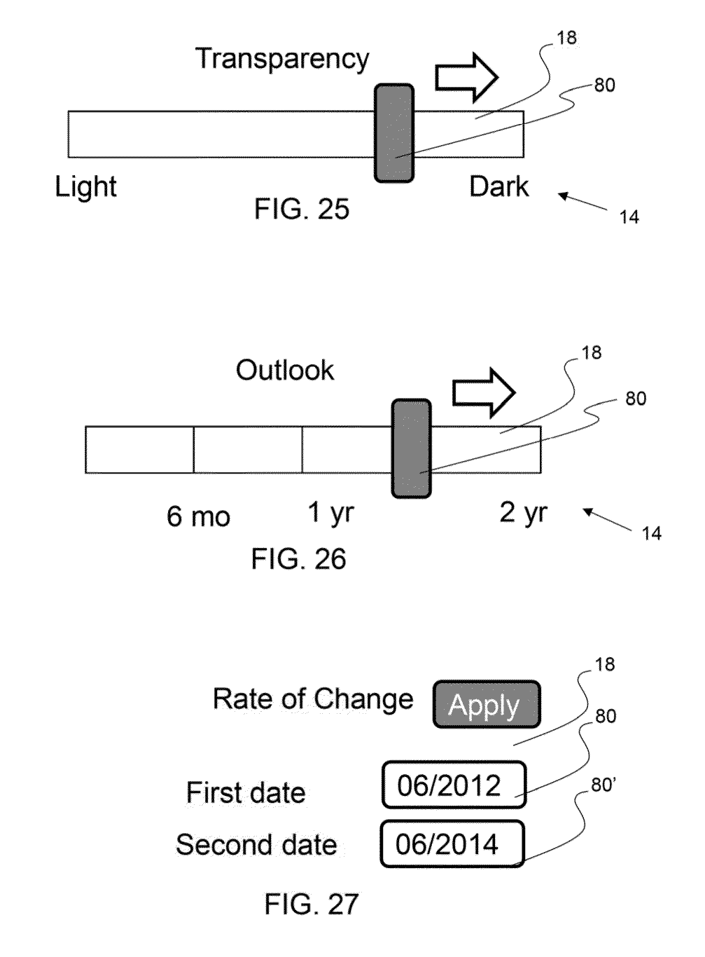

FIG. 25 shows an exemplary user interface transparency input feature.

FIG. 26 shows an exemplary user interface outlook input feature.

FIG. 27 shows an exemplary user interface rate-of-change input feature.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

Certain exemplary embodiments of the present invention are described herein and illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

A heat map, as used herein, refers to and is one embodiment of a geospatial display of location areas having specific rating colors. A conventional heat map color scheme may be used or any other suitable color, or color shade configuration may be used on a geospatial display. As described, a legend showing the rating value or range for a displayed color may be provided on a geospatial map display.

Referring to FIG. 1, a sequence of steps for acquiring geospatial data, compiling the geospatial data and providing an interactive visual representation of the geospatial data based on user input are illustration. Start defines where input data and output data are planned and investigated. Input data can be acquired from one or more vendors. Each of the vendors provides historical geospatial data under multiple categories. The historical geospatial data comprises data acquired over multiple time periods. The categories comprise national variables, metro market datasets, monthly/quarterly datasets and all national property datasets. From the acquired and evaluated geospatial data multiple variables are acquired. The variables are compiled into individual geospatial datasets and a standard database. Get data refers to capturing and compiling each and every variable below, weekly, monthly, and/or quarterly data. The variables comprise Census Block, Census Block Group, Census Tract, Zip Codes, neighborhoods, cities, counties, metro markets and states.

Each geospatial dataset comprises a plurality of geospatial database rows and database columns. As used herein, the term Census Block comprise over 7,000,000 geospatial database rows, with over 100 columns or variables. As used herein, the term Census Block Group comprises over 209,000 geospatial database rows, with over 300 columns or variables. As used herein, the term Census Tract comprise over 67,000 geospatial database rows, with over 300 columns or variables. As used herein, the term Zip Codes comprise over 43,000 geospatial database rows, with over 300 columns or variables. As used herein, the term neighborhoods comprise over 26,000 geospatial database rows, with over 200 columns or variables, As used herein, the term cities comprise over 25,000 geospatial database rows, with over 200 columns or variables. As used herein, the term counties comprise 3100 geospatial database rows, with over 100 columns or variables. As used herein, the term metro markets comprise over 800 geospatial database rows, with over 100 columns or variables. As used herein, the term states comprise 50 geospatial rows with over 100 columns or variables. Vendors, datasets, vector-based boundary sets, and technology are evaluated, and programming code is developed for integrating data. In an embodiment, the programming code is written in C++.

Consider an example, wherein four vendors, namely, vendor A, vendor B, vendor C, vendor D provide input data. Vendor A provides input data at a cost of $1500 per year, comprising over 70 national variables and must have a minimal of 10 years of historic monthly/ or quarterly datasets. Vendor B provides input data at a cost of $2500 per year comprising metro markets and 250 input variables and a minimal of 5 years of historic data, Vendor C provides input data at a cost of $22000 per year comprising over 340 monthly and/or quarterly datasets and must have a minimal of 5 years of historic data compiled for the census block levels and higher geospatial levels. Vendor D provides input data at a cost of $22000 per year comprising over $100,000 per year comprising all national property datasets are clustered into a geospatial database every week/month/ or quarter.

Variables are captured and compiled into all geospatial datasets, for each block, block group, census tract, zip code and higher geospatial levels. The geospatial databases are linked by a string, or a string of digital numbers assigned to each geospatial datasets. For example, a hypothetical Census Block number of 011797619144001 fits into its corresponding Census Block Group number of 0117976191440. In an embodiment, building a 12-month predictive model for a geospatial level requires three times the amount of data as the desired time period, For example, a 12-month predictive model requires geospatial data for over 36 months. In another example, a 24-month predictive model requires over 72 months of geospatial data for each census block, census block group, census tract, zip code and higher geospatial data.

Data may be acquired in multiple ways. For example, really simple syndication (RSS) feeds that are purchased and compiled in geospatial databases, direct purchases from vendors, compiling and clustering of real estate datasets such as inventory or the number of foreclosures, into geospatial datasets from vendors, etc. The data is compiled into two databases, namely, spatial database and a standard MySql database. The compilation of data is a critical step since the two databases do not directly communicate to each other and are not instantly query able by a user. In an embodiment, the geospatial database is combined with the standard SQL database.

FIG. 2 illustrates a system for loading of geospatial data. As used herein, the term employment numbers comprise the latest: unemployment rates, new jobs, job growth, types and sectors of job growth, new or re-hired, pre-hired employees, etc. The data sets acquired from vendors and verified and back tested for reliability. As used herein the term income numbers comprise median income, market basket, weekly expenses, disposable income, etc. As used herein, the term land user comprise size of buildable lance, permits issued, permits approved, amount of vacant land, etc. The data is purchased from vendors, verified and back tested for reliability. As used herein, the term, growth and misc comprise over 300 other variables, for example, population changes, births and deaths, changes of addresses, migration, changes in regional policies, tax rates. The data is purchased from vendors, verified and back tested for reliability.

Predictive engines are used with 24-month geospatial forecasts with statistical confidence levels. In an embodiment, the predictive engines are also used with 36 month geospatial forecasts. The system as illustrated in FIG. 2 uses 3-9 core mathematical processes, with constant evaluation as to identify the optimal combination. The mathematical processes comprise standard regression models on geospatial data and boundaries, lattes demographic data, latest economic data, latest property data clustered into spatial databases, latest real estate and local market data clustered into geospatial databases and latest news and events. For example, the mathematical processes comprise standard regression models for each Block, for all over 3,000,000 geospatial boundary levels. A formula, Y=f(X, B) is used. B in the formula denotes the unknown or the forecast. X is an independent variable. Y is the dependent variables. Non linear regressions is similar, but the relationship within datasets are independent, Geospatial temporal formulae are well documented by universities and take into account changes over distance and time not present in a particular block, tract, or state. The front end of the predictive engine is an expert system, obtained over years over development and back testing. The expert system comprises different combination of mathematical processes, hack testing of forecast for all geospatial areas and refining the expert system and rules to enhance accuracy.

Different methods or combinations of mathematical processes are tested to enhance the predictive model. The methods are re-tested every week, month, and/or quarter to enhance the accuracy of the predictive engine. In addition, the expert system comprises over a hundred geospatial rules, formulated over time to optimize the forecasts. For example, consider a rules, if the median income changed in a census block, namely x is greater than 40% during the last month or quarter, and the change in the corresponding census tract for census block x, is less than 30% during the previous month and/or quarter, that the change in the median income for census block x, is reduced in weight by 25%. Each of the rules is a part of the proprietary technology developed and tested over the years. Other rules are for example, non-direct price influences, for example, factors that are seasonal. These rules can only be viewed after years of back-testing and observations. For example, if 40% of the population within a neighborhood migrates one month and/or quarter, are these snowbirds or vacationers or are these people moving because of a plant closure. These seasonal adjustment are rules set into the expert System, based upon observation and percentage changes, as to which blocks lose populations, that are only temporary. Each of these rules change for thousands of spatial areas.

User defined heat maps as mentioned in FIG. 1 refers to the visual representation of dynamic geospatial maps that display location areas in different colors associated with a calculated rating, or value, for that location area. In one embodiment, the conventional heat map color scheme may be used to indicate high versus low ratings or values, as this may be easily appreciated by a user. The dynamic geospatial maps are generated from the geospatial forecast. It is to understood that any suitable color scheme may be used however. Heat maps can be represented by a range of 3 colors to 10 colors. The heat maps are rendered by the following sequence of steps. The user enters an address-online. The system finds and assigns the latitude and longitude coordinates for the address. The user chooses what geospatial level he wants to view for comparison with a larger geospatial level. A default setting may, for example, compare a corresponding Census Block Group to a matching Metro Market. For example, the user types in 101 Main St, Chicago, Ill. The system matches 101 Main St to its Census Block Group, and show a dynamic heat map of the Chicago Metro Market. Hence the user acquires information about the properties in Chicago. The system matches all the corresponding higher geospatial levels. With the string, mentioned above, for example, census block to county. A query is sent to the geospatial databases and the system ranks the defined Census Block Groups. The query comprises hidden code that sends rules to the databases enabling the user to view the results on the user interface. Depending on which of then ten Colors are selected, rankings are now sent to a separate sub-table, and the vector-based heat maps are drawn in real-time in the user's browser, based upon the ranking of the sub-table. These sub-tables are created, to speed up performance for the user. In an embodiment, the sub-tables can also be saved and exported for later use, so even a blind person can also access these new geospatial datasets.

The user chooses a higher geospatial level at each comparison. Referring to FIG. 3 and FIG, 4. the tables show example on how the colors are determined from the query to the geospatial database of weekly to monthly datasets and rendered in the real time dynamic maps. The color ranges are also automatically sent to the legend. As depicted in FIG. 3 and FIG. 4, there are two types of color distributions within the real time heat maps, equal distribution and high/low emphasis. FIG. 3 represents the color table for the Census Block Group (CBG) or “Hyper-Local” in the geospatial slider image. FIG. 4 represents the color table for Census Block Group (CBG) dynamic map based upon a Metro Market of 600 CBG's.

The benefit to the user in viewing the real time dynamic maps using the high/low emphasis ranges is that the user can instantly view, find, and export the dynamic maps into a table. The top 1% or the top 6 of 800 CBG's or for any set of geospatial datasets. The list of geospatial datasets comprise census block (CB) with 209,000 per each geospatial sets, Census Block Group (CBG) with 67,000 per each geospatial sets, zip code (ZC) with 43,000 per each geospatial sets, neighborhood with 28,000 per each geospatial sets, city with 22,000 per each geospatial sets, counties with 3,100 per each geospatial sets, metro markets with 400 per each geospatial sets, states with 52 per each geospatial sets and national with 1 per each geospatial set.

FIG. 5 represents different types of geospatial sliders. The different types of sliders comprise block group slider census tract slider, zip code slider, city slider, county slider, and metro market slider. The different sliders allow the user to instantly query the database using a visual element resulting in the system dynamically drawing a heat map. The user slides the spatial slider allowing the user to dynamically access all spatial boundary information via a report, a form, a web page or a dynamic map. The slider moves from one geospatial to another. Hence heat maps are instantly rendered and drawn based on the user preference and choice. For example, the slider moves from property to census block to census block group to zip code to neighborhood to city to metro market to state to national. User defined dynamic geospatial maps are rendered as heat maps. Each variable is represented in the range of 3 colors to 10 colors. The sliders allow maps to be drawn in real time as illustrated in FIG. 6.

Ranked or user defined weighted tiered query as referred to in FIG. 1 relates to the user provided with a user defined ranked or tiered weighted search comprising multiple choices for generating the dynamic geospatial maps as illustrated in FIG, 7. FIG. 7 shows how a user who needs to find a geospatial area, a block or a block group, that has a high expected forecast changes in appreciation, with good cash flow, and good growth. This user picks these as 1, 2, and 3. The query would be sent to the geospatial database, thus instantly render the maps based upon what the user wants. FIG. 7 also shows an advanced option or the tiered weighted search. In the tiered weighted search, the user can insert numbers of 50% or 60%. This option is mostly for businesses. The more advanced option is the tiered weighted search. In this case 1, 2 and 3 were replaced by 50%, 35% and 15%.

Referring to FIG. 8, the geospatial slider also allows for user-defined interactive reports with one geospatial slider. Another option is user-defined interactive reports with two geospatial sliders as illustrated in FIG. 9.

A core problem for property sales people, for example, agents, brokers, realtors, etc. of all scoring type reports, and reports that have forecasts, is that if the generated score is low then the forecast is negative. Negative forecasts do not help the salesperson, Additionally, for the real estate appraiser may only want a report that just shows the latest local treads, and not the forecasts. Thus, embodiments may include the following reports:

Report type 1 offers geospatial datasets that consumers are familiar. The geospatial datasets are positive in the above 75% percentile. Thus block, block groups, and census tracts are not present in this report. Only data that is positive is reported for these more common terms. For example, for a report for zip code 95125 that is comparing this zip code to its County of Santa Clara County, if the latest job growth trend in Zip Code 95125 is less than 75% it is not in the report, if it is greater, then it is in the report. The report goes through all different types of scenarios and relationship, and this query to the database, shows a report with dynamically rendered heat maps in this report. Thus the salesperson can go sell and get listings, and only lay emphasis the positive.

Report type 2 is similar to report type 1, but includes all geospatial datasets. Report type 3 is similar to report type 2, but the agent/broker/realtor can choose the exact percentile, for example, 67.5% for this report. Report type 4 is where the individual agent/broker/realtor, who are familiar with geospatial datasets, can look at all the data, and choose what date to show in the report. For example, in report 1, the agent, broker or realtor may also want to show a variable within the report that is less than 75%, hence they have this option. Report type 5 is a report for appraisers, which does not include predictive analytics and is a value added feature to their standard appraisal reports. These standard appraisal reports typically describe if the market is bad, fair, average or good, which does not help underwriters in assessing risk.

Report type 6 is an underwriter's report, which is similar to a basic report illustrated above, but also contains standard property datasets.

Report type 7 is a report that traders for mortgage backed securities (MBS) would use to adequately assess future risks and returns for these securities. It may also be possible to add to the invention disclosed herein and predictive analytics to trading platforms such as Bloomberg or Reuters. Report type 8 is a report and online system that asses risk for real estate securities post origination. This assessment is only done after the security is originated and sold, The buyer of these securities then can use a risk assessment tool, to determine if they should hold or sell this security during the holding period; while monitor local block, block group, and census tract changes that affect the risk of their security and portfolio.

Based on the reports the user selects the home criteria as referred to in FIG. 1 and finds the optimal investment. The optimal investment is obtained from the tiered weighted search query in combination with the user defined query. Additionally the user is provided with options to create a customized homepage based on the user's preferences. The user is provided with a spatial slider, using which the content on the homepage is altered.

In an embodiment, multiple external websites send input data to the server. In response the present invention provides an application programming interface to the external websites to facilitate user experience on the external website. In another embodiment, the present invention can be displayed on other external websites either as a widget, an application or an i-frame. For example, dating websites can display a widget of the present invention. When a user clicks the widget, a heat map is generated to display the number of singles in a geographical area.

FIG. 10 shows an exemplary display 14 of some of the exemplary user input interface 80 options. For example, a user may select market variables, consumer profiles, or property attributes through the user interface feature 18. Market variables may include criteria related to property within a location area, including, but not limited to, time on market, average residential home sale values, etc. Consumer profile variables may include average household income, average age of residents within a location area, marital status of residents with a location area and the like. Property attributes may include physical attributes of a home, including size of the home, size of the parcel and the like. p FIG. 11 shows an exemplary representation of a display 14 of a user input feature 80 for selecting market variables. A user may use the input interface feature 18 to select market variables by clicking on the icon, and then select from the variable list to add them to the input field box to the right by clicking on the arrows. This second input feature 18′ enables a user to quickly add and subtract input variable for analysis by the dynamic geospatial rating and display system, as described herein. When a user has selected the desired variables, they may click on the draw map icon, to initiate the display of the geospatial map.

FIG. 12 shows a top-down view of an exemplary representation of a user 12 interfacing with a computer 16 having a display 14 and a dynamic geospatial rating and display system 10 as described herein. The user 12 is using the user interface 19, a keyboard, to select input variables for analysis. The computer 16 is coupled with a database 20 that may run the analysis and have the data stored thereon.

FIG. 13 shows an exemplary display 14 of a geospatial map 15 on a tablet computer 14; wherein each of said plurality of location areas 40 are displayed in a rating color relative their computed rating. A legend 22 is provided to show the rating value range for each color displayed.

FIG. 14 shows an exemplary representation of a display 14 of a user input feature 80 for property attributes. There are a number of user interface features, including box selections for a number of input variables including, “For Sale”, “PreMarket”, “For Rent”, and “Recently Sold.” In addition, a user may input a desired min and max price as well as other input fields. When all of the property attributes desired have been input, a user may select the draw map icon to see a geospatial map that incorporates the property attributes input.

FIG. 15 shows an exemplary display 14 of a geospatial map 15, wherein each of a plurality of location areas 40 are displayed in a rating color relative their computed rating of home prices. This exemplary geospatial map shows the average home prices by block with a selected area 24.

FIG. 16 shows an exemplary display 14 of a geospatial map 15, wherein each of a plurality of zip code location areas 40 are displayed in a rating color relative their computed rating.

FIG. 17 shows an exemplary display 14 of a geospatial map 15, wherein each of a plurality of tract location areas 40 are displayed in a rating color relative their computed rating.

FIG. 18 shows an exemplary display 14 of a geospatial reap 15, wherein each of a plurality of block location areas 40 are displayed in a rating color relative their computed rating.

FIG. 19 shows an exemplary display 14 of a geospatial map 15, wherein each of a plurality of block location areas 40 are displayed in a rating color relative their computed rating that has been filtered by a user. A user may have filtered the results by a filter input feature, whereby a user can exclude location areas that are above or below some rating or input variable value.

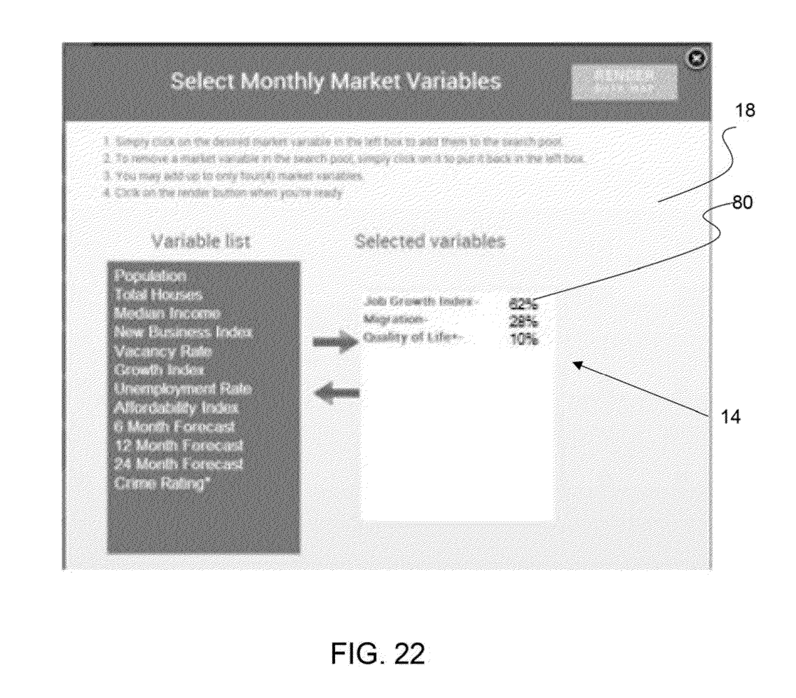

FIGS. 20 through 22 show exemplary displays 14 of a user input interface feature 18 for selection of variables with an associated weight. The weighted input feature 80 enables a user to input a weight for a specific input variable or field. As shown in FIG. 22 the input weight is 100% when only one input variable is selected. As shown in FIG. 21, the weigh is 50% for the two variables selected. A user may change the weight of a first input variable, job growth, for example, to 80% and the weight of a second input, migration to 20%. As shown in FIG. 22, three input variable are selected and each have been assigned a different weight, 62%, 28% and 10% that sum to 100%.

FIG. 23 shows an exemplary display 14 of a table having computed ratings for block, track, county and national.

FIG. 24 shows an exemplary display 14 of a table having computed ratings for combined attributes including property data attributes and socio-economic attributes.

FIG. 25 shows an exemplary user interface feature 18 that is a transparency input feature 80. A user may simply click-on and slide the bar to change the intensity or darkness of a color over a location area.

FIG. 26 shows an exemplary user interface feature 18 that is an outlook input feature 80. A user may simply click-on and slide the bar to change the outlook period. As shown in FIG. 26, the user has selected an 18 month outlook. In another embodiment, a user may type in an outlook date.

FIG. 27 shows an exemplary user interface feature 18 that is a rate-of-change input feature 80. As shown, a user may type in a first date and a second date, whereby an algorithm will compute the rate of change of selected variable over that period. In another embodiment, a user may select a click and drag a first date bar and a second date bar on a timeline to select a rate of change period.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A dynamic geospatial rating and display system comprising:
a. a computer implement comprising:
i. a display screen;
ii. a user interface;
b. a software coupled with said computer implement comprising:
i. a database comprising:
1. property data;
ii. an algorithm that computes a rating for a plurality of location areas as a function of said property data;
whereby said rating is displayed as a geospatial map on said display screen;
wherein each of said plurality of location areas are displayed in a rating color relative their computed rating;
c. a user field selection feature comprising:
i. a first field input;
ii. a second field input;
whereby said algorithm computes a rating utilizing data related to said first and second field inputs;
whereby said user can change said first field input and said display is changed dynamically as a function of user field input changes.

2. The dynamic geospatial rating and display system of claim 1, wherein the database further comprises:
a. socio-economic data;
whereby the algorithm is configured to computes a rating for a plurality of location areas as a function of said socio-economic data.

3. The dynamic geospatial rating and display system of claim 1, comprising a location area selector feature, whereby a user can selected a selected area, whereby the algorithm computes ratings for a plurality of location areas within said selected area and wherein each of said plurality of location areas are displayed in a rating color relative their computed rating.

4. The dynamic geospatial rating and display system of claim 2, wherein the area selector feature comprises:
a. a state setting;
b. a region setting; and
c. a city setting.

5. The dynamic geospatial rating and display system of claim 1, comprising a resolution selector feature, whereby a user can select a resolution of display, whereby resolution of said plurality of location areas is changed by said resolution of display selection.

6. The dynamic geospatial rating and display system of claim 1, wherein the resolution selector feature comprises:
a. a zip code setting;
b. a tract setting; and
c. a block setting.

7. The dynamic geospatial rating and display system of claim 1, wherein the property data comprises residential property data and commercial property data comprising:
a. property value;
b. property size.

8. The dynamic geospatial rating and display system of claim 2, wherein the socio-economic data comprises residential data comprising:
a. residential income data,
b. gender data
c. race data;
d. consumer profile data; and
e. household expenditures type profile data.

9. The dynamic geospatial rating and display system of claim 2, wherein the socio-economic data comprises commercial data comprising:
a. business density;
b. commercial income data;
c. business profile date; and
d. business expenditures type profile data.

10. The dynamic geospatial rating and display system of claim 2, wherein the property data and socio-economic data is aggregated and a median is used by the algorithm to calculate a rating for the plurality of location areas.

11. The dynamic geospatial rating and display system of claim 1, further comprising a predictive algorithm, wherein the property data comprises historical property data that is at least four years prior to use of said dynamic geospatial rating and display system and whereby and whereby said predictive algorithm utilizes said historical property data to compute a predictive future rating.

12. The dynamic geospatial rating and display system of claim 11 further comprising a predictive algorithm, wherein the socio-economic data comprises historical socio-economic data that is at least four years prior to use of said dynamic geospatial rating and display system and whereby said predictive algorithm utilizes said historical socio-economic data to compute a predictive future rating.

13. The dynamic geospatial rating and display system of claim 1, further comprising an outlook user feature, whereby a user can select an outlook time for a display of said predicted future ratings for a plurality of location areas and wherein said outlook time comprises an at least six month outlook time.

14. The dynamic geospatial rating and display system of claim 2, further comprising an outlook user feature, whereby a user can select an outlook time for a display of said predicted future ratings for a plurality of location areas and wherein said outlook time comprises an at least six month outlook time.

15. The dynamic geospatial rating and display system of claim 11, wherein the predictive algorithm computes a rate of change rating for a plurality of locations;
whereby said rate of change rating is displayed as a geospatial map on the display screen;
wherein each of said plurality of location areas are displayed in a rate of change color relative their computed rate of change rating.

16. The dynamic geospatial rating and display system of claim 12, wherein the predictive algorithm computes a rate of change rating for a plurality of locations;
whereby said rate of change rating is displayed as a geospatial map on the display screen;
wherein each of said plurality of location areas are displayed in a rate of change color relative their computed rate of change rating.

17. The dynamic geospatial rating and display system of claim 11, wherein a rate-of-change input feature comprises:
a. a first date input field; and
b. a second date input field;
whereby the rate of change is calculated between said first date and said second date.

18. The dynamic geospatial rating and display system of claim 12, wherein a rate-of-change input feature comprises:
a. a first date input field; and
b. a second date input field;
whereby the rate of change is calculated between said first date and said second date.

19. The dynamic geospatial rating and display system of claim 1, further comprising a weighting field input feature, whereby a user can select a first weight for a first input field and a second weight for a second input field,
whereby the algorithm utilizes said first weight and said second weight in the computation of a rating for a plurality of location areas.

20. The dynamic geospatial rating and display system of claim 1, further comprising a rating color transparency feature, whereby a user can change a transparency of a rating color of said plurality of location areas.

21. A dynamic geospatial rating and display system comprising:
a. a computer implement comprising:
i. a display screen;
ii. a user interface;
b. a software coupled with said computer implement comprising:
i. a database comprising:
1. current property data;
2. historical property data that is at least four years prior to use of said dynamic geospatial rating and display system;
3. socio-economic data;
4. historical socio-economic data that is at least four years prior to use of said dynamic geospatial rating and display system
ii. a current status algorithm that computes a rating for a plurality of location areas as a function of said current property data and/or current socio-economic data;
iii. an predictive algorithm that computes a rating for a plurality of location areas as a function of said current and historical property data and/or said current and historical socio-economic data;
whereby said rating is displayed as a geospatial map on said display screen; wherein each of said plurality of location areas are displayed in a rating color relative their computed rating;
c. a user field selection feature comprising:
i. a first field input;
ii. a second field input;
whereby said algorithm computes a rating utilizing data related to said first and second field inputs;
whereby said user can change said first and/or second field input and said display is changed dynamically as a function of user field input changes;
d. an outlook user feature;
whereby a user can select a display of a predicted future rating or a plurality of location areas.
